(19) United States
(12) Patent Application Publication
(10) Pub. No.: US 2019/0078670 A1
(43) Pub. Date: Mar. 14, 2019

(54) ACTUATOR CAPABLE OF PROVIDING LINEAR THRUST

(71) Applicant: OKIN Refined Electric Technology Co., Ltd., Jiaxing Zhejiang (CN)

(72) Inventors: Ming Long LEI, Jiaxing Zhejiang (CN); Long LI, Jiaxing Zhejiang (CN)

(21) Appl. No.: 15/913,228

(22) Filed: Mar. 6, 2018

(30) Foreign Application Priority Data
Sep. 13, 2017 (CN) 201721168562.2
Jan. 9, 2018 (CN) 201820031324.5

(51) Int. Cl. F16H 25/20

(52) U.S. Cl. CPC F16H 25/2015; F16H 2025/2031; F16H 2025/209

(57) ABSTRACT

An actuator capable of providing a linear thrust comprising a motor, a worm gear, a worm, a screw rod and a base; the base is arranged on the motor, and the worm is propelled by the motor; the worm can rotate to propel the worm gear to rotate, and the screw rod is in threaded connection with the worm gear; the motor can rotate to propel the worm gear through the worm, and the motor linearly moves relative to the screw rod.

### BACKGROUND OF THE INVENTION

Chinese patent CN101636600B discloses an electric linear actuating device used for adjusting furniture members, which comprises an injection-molded plastic shell with a multi-piece structure, an actuating motor and a screw rod capable of being propelled to rotate. A sliding-block type screw nut that is prevented from rotating is then arranged on the screw rod. The screw nut partially surrounds the shell, or the screw nut is partially embedded into the shell. The shell that is formed by two shell parts is provided with a screw nut slide-way. The screw threads of the screw rod are arranged outside the shell within an area that the shell interacts with the screw rod. The split-surface of the shell extends along a longitudinal axis of the screw rod. The screw nut is locked onto to the shell parts. Specifically, the screw nut can be propelled to move relative to the shell.

In the prior art, the aforesaid pushing motor utilizes a screw nut that is in a threaded connection with the screw rod and is capable of sliding in a reciprocating mode to achieve a pushing effect. However, during the installation of the pushing motor, the stress member is connected to the screw nut, and the connection point is usually arranged on a single side, leading to problems such as uneven stress. Thus, the functional life of the motor can be severely affected.

Chinese patent CN103812266B also discloses a waterproof actuating mechanism, which comprises a worm gear, a screw rod, a movable ring, a push rod and a push rod support. The push rod support is fixed on the shell, and the left end of the screw rod is connected to a rear support member through a bearing. The worm gear is arranged on the screw rod, and the worm gear interacts with the main shaft worm. The right end of the worm gear is sleeved with a positioning spring, and the end of the positioning spring is provided with a hook, through which the positioning spring is fixed on the main body base. The screw rod and the movable ring are in a spiral fit, and the right end of the movable ring is fixedly connected to the push rod. The screw rod, the movable ring and the push rod are arranged in the push rod support after being connected. The right end of the push rod extends out of the push rod support, and is provided with a pin shaft sleeve. A travel assembly is further arranged in the push rod support. The movable ring and the push rod reciprocate within the push rod support through the rotation of the screw rod.

Although the aforesaid invention solves the technical problem relating to the uneven stress through using a movable ring to propel the push rod, the push rod and the push rod support added in the structure increase the manufacturing cost and cause an energy loss.

### SUMMARY OF THE INVENTION

The purpose of the present invention is to solve the shortcomings in the prior art by providing an actuator capable of providing a linear thrust, which has a reasonable structure, a low manufacturing cost and a low energy consumption.

To achieve the above purpose, the present invention adopts the following technical solution:

An actuator capable of providing a linear thrust comprising a motor, a worm gear, a worm, a screw rod and a base; the base is arranged on the motor, and the worm is propelled by the motor; the worm can rotate to propel the worm gear to rotate, and the screw rod is in threaded connection with the worm gear; the motor can rotate to propel the worm gear through the worm, and the motor linearly moves relative to the screw rod.

In another aspect of the present invention, the actuator further comprises a micro-switch and a positioning member. The positioning member is arranged on the screw rod. When the motor linearly moves relative to the screw rod, the positioning member can trigger the micro-switch so that the motor can be stopped.

In another aspect of the present invention, each side of the worm gear is provided with a rotating shaft. A groove used for mounting the rotating shaft is formed in the base, and the rotating shaft can rotate in a circumferential direction within the groove. The central axis of the rotating shaft is a cavity, and the screw rod extends throughout the worm gear and the rotating shaft.

In another aspect of the present invention, the interior of the rotating shaft is provided with inner threads.

In another aspect of the present invention, the positioning member is in threaded connection with the screw rod, and the position of the positioning member can be adjusted.

In another aspect of the present invention, the base further comprises an upper cover and a lower cover. The worm gear and the worm are hermetically installed in the base after the upper cover and the lower cover are assembled. The upper cover and the lower cover are respectively provided with a semi-arc groove used for mounting the rotating shaft. After the upper cover and the lower cover are closed, the rotating shaft is located in the arc-shaped groove.

In another aspect of the present invention, there're two micro-switches and two positioning members. The two micro-switches and the two positioning members are respectively arranged on two sides of the worm gear.

In another aspect of the present invention, the actuator further comprises a mounting support used for mounting the actuator. The mounting support further comprises a bottom plate, side plates and a supporting plate. The bottom plate is provided with an opening. The side plates that are respectively arranged on the two sides of the opening are fixed to the bottom plate. The supporting plate is fixed to the bottom plate and the side plates. A positioning shaft is arranged on the base. When mounting the actuator onto the mounting support, the positioning shaft is embedded into the opening.

In another aspect of the present invention, the bottom plate comprises a left side edge, a right side edge and a middle edge. The two ends of the middle edge are respectively connected to the left side edge and the right side edge. The middle edge, the left side edge and the right side edge are located on different horizontal planes.

In another aspect of the present invention, the actuator further comprises a mounting support used for mounting the actuator. The mounting support is horizontally arranged, and is fixed to the base.

In another aspect of the present invention, the actuator capable of providing a linear thrust of claim 1 further comprises a mounting support used for mounting the actuator. The mounting support comprises an upper support and a lower support. The upper support is fixed to the upper cover, and the lower support is fixed to the lower cover. The mounting support is vertically arranged, and the upper support and the lower support are located on the same reference plane after being assembled.

In another aspect of the present invention, the actuator further comprises a tube sleeve, and the tube sleeve is sleeved outside the screw rod.

In another aspect of the present invention, the actuator further comprises a mounting support used for mounting the actuator. The mounting support comprises an upper support and a lower support. The upper support is fixed to the upper cover, and the lower support is fixed to the lower cover. Both the upper support and the lower support are respectively provided with a U-shaped groove.

In another aspect of the present invention, the actuator further comprises two damping pieces. Each damping piece comprises a circular ring portion and a plurality of convex bodies that protrude out from the circular ring portion. The circular ring portion is fixed to the convex bodies, and the convex bodies are symmetrically arranged on the periphery of the circular ring portion. The two damping pieces are respectively arranged on two sides of the worm gear. The convex bodies abut against the upper cover and the lower cover.

Compared with the prior art, the present invention has the following advantages:

First, the present invention can impose an even pushing force during operation, greatly improving the operating stability and durability of the motor;

Second, the present invention has a simple and reasonable structure. As the push rod and the push rod support adopted in the prior art are saved, the manufacturing cost is reduced and the integral energy efficiency is improved.

### BRIEF DESCRIPTION OF THE DRAWINGS

To clearly expound the technical solution of the present invention, the drawings and embodiments are hereinafter combined to illustrate the present invention. Obviously, the drawings are merely some embodiments of the present invention and those skilled in the art can associate themselves with other drawings without paying creative labor.

FIG. 1 is a schematic diagram showing an assembled structure of the present invention;

FIG. 2 is a schematic diagram showing the state when the mounting support is separated from the present invention;

FIG. 3 is an explosive view of the present invention;

FIG. 4 is a structural diagram of the mounting support of the present invention;

FIG. 5 is a schematic diagram of the control circuit of the present invention;

FIG. 6 is another structural diagram of the mounting support of the present invention;

FIG. 7 is another structural diagram of the mounting support of the present invention;

FIG. 8 is another structural diagram of the mounting support of the present invention; and

FIG. 9 is a structural diagram showing the state after the damping pieces are assembled.

### DETAILED DESCRIPTION OF THE INVENTION

Drawings and detailed embodiments are combined hereinafter to elaborate the technical principles of the present invention.

### Embodiment 1

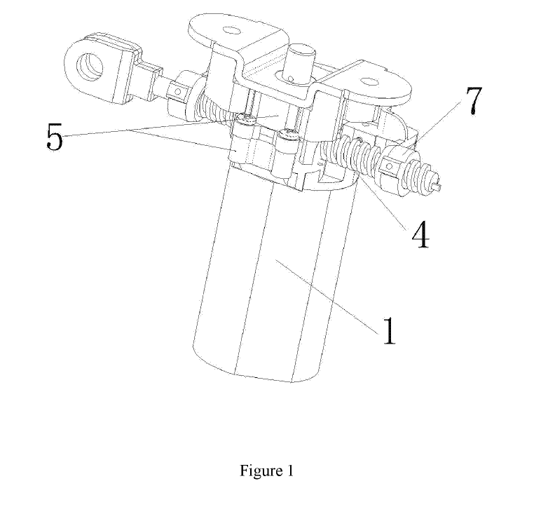

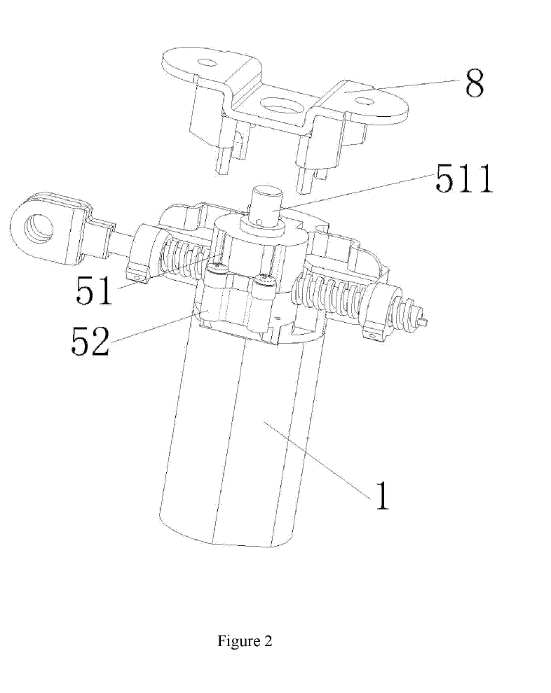

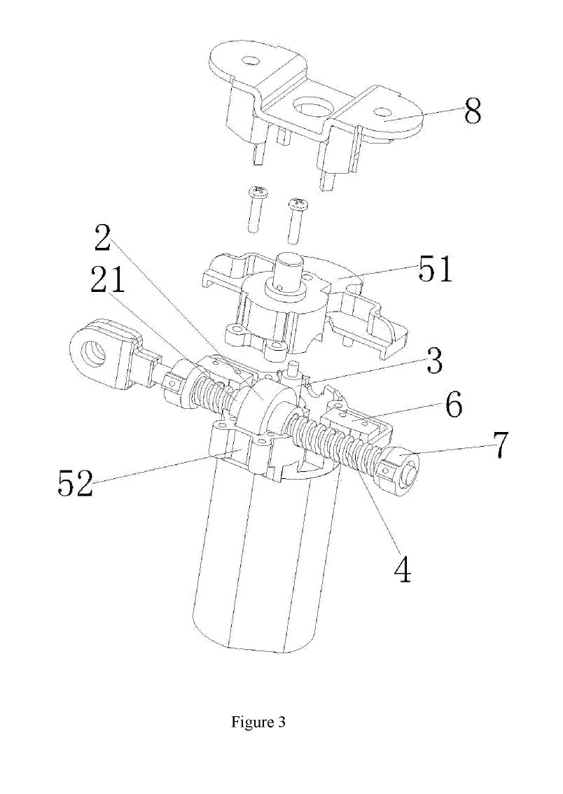

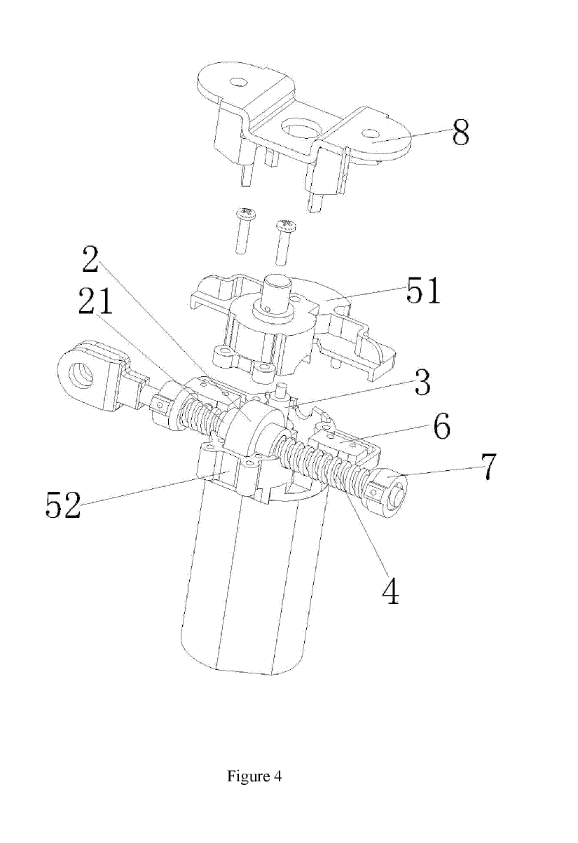

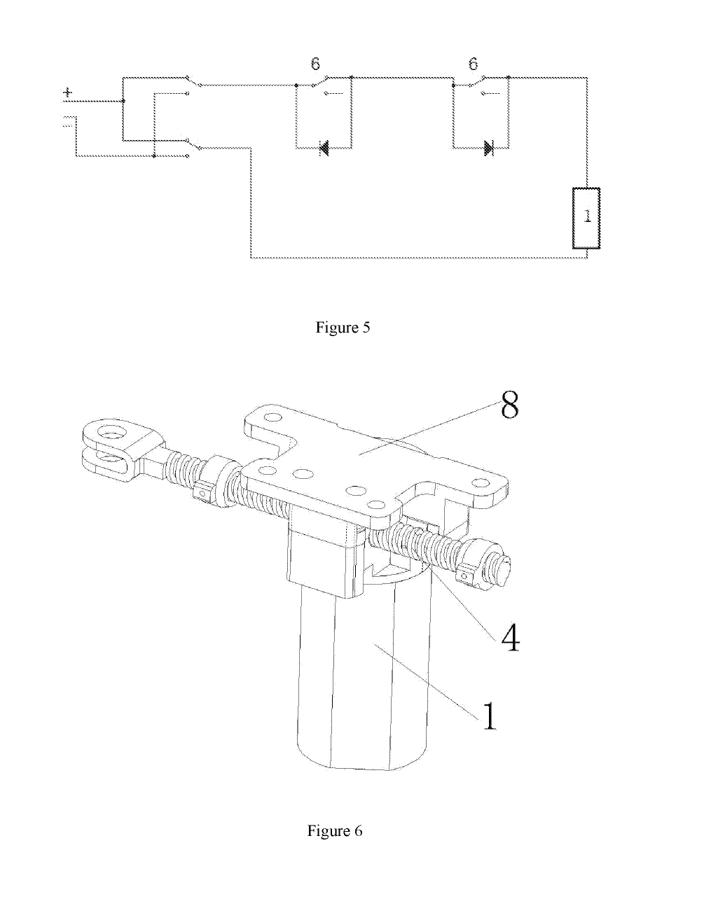

As shown in FIGS. 1-4, the actuator capable of providing a linear thrust comprises a motor 1, a worm gear 2, a worm 3, a screw rod 4 and a base 5. The base 5 is arranged on the motor 1, and the worm 3 is propelled by the motor 1. The worm 3 can rotate to propel the worm gear 2 to rotate, and the screw rod 4 is in threaded connection with the worm gear 2. The motor 1 can rotate to propel the worm gear 2 through the worm 3, and the motor 1 linearly moves relative to the screw rod 4. In this embodiment, when the motor 1 rotates, a force conversion can be achieved through the worm gear 2 and the worm 3, enabling the screw rod 4 to directly generate a thrust. Thus, the screw rod 4 is a direct source for generating the thrust. Compared with the prior art, the present invention can save structural components, and reduce the energy loss during the energy conversion process.

In this embodiment, the present invention further comprises a micro-switch 6 and a positioning member 7. The positioning member 7 is arranged on the screw rod 4. When the motor 1 linearly moves relative to the screw rod 4, the positioning member 7 can trigger the micro-switch 6 so that the motor can be stopped. The micro-switch 6 is arranged on a control circuit of the motor 1, and the micro-switch 6 can be triggered to switch-off the control circuit of the motor 1, thereby stopping the motor 1.

Furthermore, each side of the worm gear 2 is fixedly provided with a rotating shaft 21. A groove used for mounting the rotating shaft 21 is formed in the base 5, and the rotating shaft 21 can rotate in a circumferential direction within the groove. The central axis of the rotating shaft 21 is a cavity, and the screw rod 4 extends throughout the worm gear 2 and the rotating shaft 21. Preferably, the rotating shaft 21 and the worm gear 2 are in one body. The worm gear 2 can be positioned by the rotating shaft 21. Thus, the assembly efficiency can be greatly improved, and the manufacturing cost can be effectively reduced.

In this embodiment, the interior of the rotating shaft 21 is provided with inner threads. Preferably, the worm gear 2 is in threaded connection with the covered portion of the screw rod 4. Thus, a longer length of the threaded connection can be achieved.

The positioning member 7 is in threaded connection with the screw rod 4, and the position of the positioning member 7 can be adjusted. This threaded connection allows the positioning member 7 to be adjusted in a step-less manner.

The base 5 further comprises an upper cover 51 and a lower cover 52. The worm gear 2 and the worm 3 are hermetically installed in the base 5 after the upper cover 51 and the lower cover 52 are assembled. The upper cover 51 and the lower cover 52 are respectively provided with a semi-arc groove used for mounting the rotating shaft 21. After the upper cover 51 and the lower cover 52 are closed, the rotating shaft 21 is located in the arc-shaped groove.

In this embodiment, the present invention further comprises a mounting support 8 used for mounting the actuator. The mounting support 8 further comprises a bottom plate 81, side plates 82 and a supporting plate 83. The bottom plate 81 is provided with an opening 810. The side plates 82 that are respectively arranged on the two sides of the opening 810 are fixed to the bottom plate 81. The supporting plate 83 is fixed to the bottom plate 81 and the side plates 82. A positioning shaft 511 is arranged on the base 5. When mounting the actuator onto the mounting support 8, the positioning shaft 511 is embedded into the opening 810. After the actuator and the mounting support 8 are assembled, the side plate 82 becomes a stressed surface, and the supporting plate 83 forms a triangular support when the screw rod stretches and contracts left and right. Thus, the actuator can be further stabilized, and an accurate operation can be achieved through the opening 810.

The bottom plate 81 comprises a left side edge 811, a right side edge 813 and a middle edge 812. The two ends of the middle edge 812 are respectively connected to the left side edge 811 and the right side edge 813. The middle edge 812, the left side edge 811 and the right side edge 813 are located on different horizontal planes.

FIG. 6 shows another embodiment of the mounting support 8, wherein the mounting support 8 resembles a flat plate. The mounting support 8 is horizontally arranged, and is fixed to the base 5.

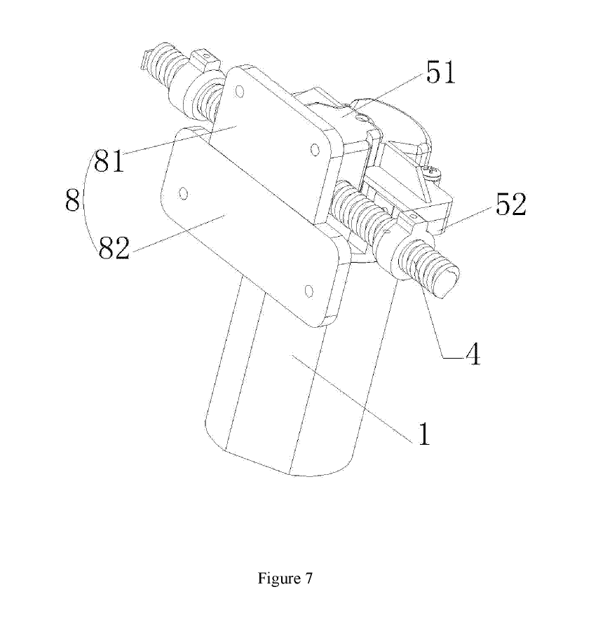

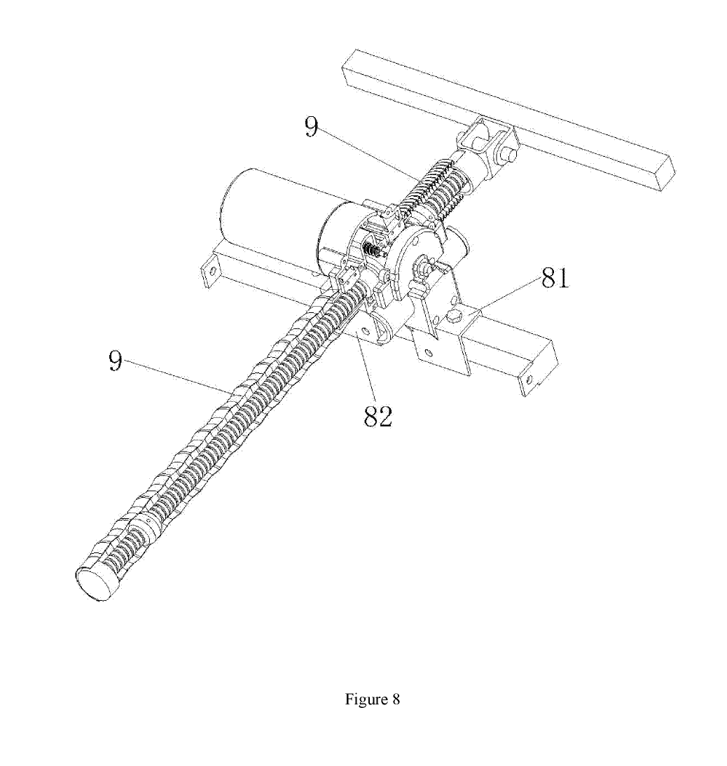

Another embodiment of the mounting support 8 is shown in FIG. 7, wherein the mounting support 8 comprises an upper support 81 and a lower support 82. The upper support 81 is fixed to the upper cover 51, and the lower support 82 is fixed to the lower cover 52. The mounting support 8 is vertically arranged, and the upper support 81 and the lower support 82 are located on the same reference plane after being assembled.

As shown in FIG. 8, the present invention further comprises a tube sleeve 9, and the tube sleeve 9 is sleeved outside the screw rod. The tube sleeve 9 is a plastic corrugated pipe, which becomes shorter when being pushed, and becomes longer when being pulled.

In this embodiment, the present invention further comprises an upper support 81 and a lower support 82. The upper support 81 is fixed to the upper cover 51, and the lower support 82 is fixed to the lower cover 52. Both the upper support 81 and the lower support 82 are respectively provided with a U-shaped groove. The U-shaped groove is capable of covering multiple faces of the actuating hardware. Thus, a stable and reliable structure can be achieved.

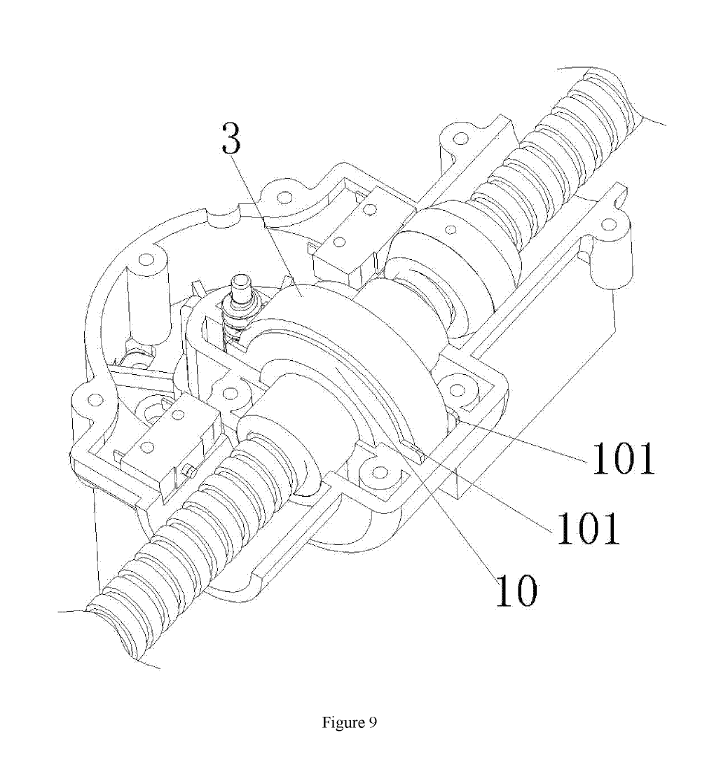

As shown in FIG. 9, the present invention further comprises two damping pieces 10. Each damping piece 10 comprises a circular ring portion and a plurality of convex bodies 101 that protrude out from the circular ring portion. The circular ring portion is fixed to the convex bodies 101, and the convex bodies 101 are symmetrically arranged on the periphery of the circular ring portion. The two damping pieces 10 are respectively arranged on two sides of the worm gear 2. The convex bodies abut against the upper cover 51 and the lower cover 5. The damping pieces 10 abut against the worm gear 2, thereby imposing a force to the worm gear 2. The damping pieces 10 separate the worm gear 2 from the upper cover 51 and the lower cover 52. Thus, the direct friction among them can be avoided and the operating stability can be improved. The damping piece is a smooth metal part, and can reduce the operating resistance.

In this embodiment, there're two micro-switches 6 and two positioning members 7. The two micro-switches 6 and the two positioning members 7 are respectively arranged on two sides of the worm gear 2. During use, the screw rod 4 is connected to a pushed member through a connecting head. When the worm gear 2 rotates, the screw rod 4 can be propelled to move. In this embodiment, the present invention further comprises a control circuit. The control circuit comprises a button and two diodes. The button comprises at least two key-switches. The two micro-switches are connected in a series, and the two diodes are connected to the two micro-switches in parallel. The two diodes are arranged back-to-back; namely, the positive electrodes of the two diodes sharing a public connection point. When one key-switch is pressed, one diode is switched-on and the other diode is switched-off. When the actuator is initiated, the positioning member 7 starts to move. Once the positioning member 7 abuts against one micro-switch 6, the micro-switch 6 is switched-off immediately. When pressing the other key-switch, the diode in a switched-off state is switched-on, and the diode in a switched-on state is switched-off. At this moment, the actuator is reversely initiated until the positioning member 7 abuts against the other micro-switch 6.

The description of above embodiments allows those skilled in the art to realize or use the present invention. Without departing from the spirit and essence of the present invention, those skilled in the art can combine, change or modify correspondingly according to the present invention. Therefore, the protective range of the present invention should not be limited to the embodiments above but conform to the widest protective range which is consistent with the principles and innovative characteristics of the present invention. Although some special terms are used in the description of the present invention, the scope of the invention should not necessarily be limited by this description. The scope of the present invention is defined by the claims.

1. An actuator capable of providing a linear thrust, comprising:
a motor,
a worm gear,
a worm,
a screw rod, and
a base, wherein the base is arranged on the motor, and the worm is propelled by the motor, wherein the worm can rotate to propel the worm gear to rotate, and the screw rod is in threaded connection with the worm gear, wherein the motor can rotate to propel the worm gear through the worm, and the motor linearly moves relative to the screw rod.

2. The actuator capable of providing a linear thrust of claim 1, wherein the actuator further comprises a micro-switch and a positioning member, wherein the positioning member is arranged on the screw rod, wherein when the motor linearly moves relative to the screw rod, the positioning member can trigger the micro-switch so that the motor can be stopped.

3. The actuator capable of providing a linear thrust of claim 1, wherein each side of the worm gear is provided with a rotating shaft, wherein a groove used for mounting the rotating shaft is formed in the base, and the rotating shaft can rotate in a circumferential direction within the groove, wherein the central axis of the rotating shaft is a cavity, and the screw rod extends throughout the worm gear and the rotating shaft.

4. The actuator capable of providing a linear thrust of claim 3, wherein the interior of the rotating shaft is provided with inner threads.

5. The actuator capable of providing a linear thrust of claim 2, wherein the positioning member is in threaded connection with the screw rod, and the position of the positioning member can be adjusted.

6. The actuator capable of providing a linear thrust of claim 3, wherein the base further comprises an upper cover and a lower cover, wherein the worm gear and the worm are hermetically installed in the base after the upper cover and the lower cover are assembled, wherein the upper cover and the lower cover are respectively provided with a semi-arc groove used for mounting the rotating shaft, wherein after the upper cover and the lower cover are closed, the rotating shaft is located in the arc-shaped groove.

7. The actuator capable of providing a linear thrust of claim 2, wherein there're two micro-switches and two positioning members, wherein the two micro-switches and the two positioning members are respectively arranged on two sides of the worm gear.

8. The actuator capable of providing a linear thrust of claim 1, wherein the actuator further comprises a mounting support used for mounting the actuator, wherein the mounting support further comprises a bottom plate, side plates and a supporting plate, wherein the bottom plate is provided with an opening, wherein the side plates that are respectively arranged on the two sides of the opening are fixed to the bottom plate, wherein the supporting plate is fixed to the bottom plate and the side plates, wherein a positioning shaft is arranged on the base, wherein when mounting the actuator onto the mounting support, the positioning shaft is embedded into the opening.

9. The actuator capable of providing a linear thrust of claim 8, wherein the bottom plate comprises a left side edge, a right side edge and a middle edge, wherein the two ends of the middle edge are respectively connected to the left side edge and the right side edge, wherein the middle edge, the left side edge and the right side edge are located on different horizontal planes.

10. The actuator capable of providing a linear thrust of claim 1, wherein the actuator further comprises a mounting support used for mounting the actuator, wherein the mounting support is horizontally arranged, and is fixed to the base.

11. The actuator capable of providing a linear thrust of claim 1, wherein the actuator further comprises a mounting support used for mounting the actuator, wherein the mounting support comprises an upper support and a lower support, wherein the upper support is fixed to the upper cover, and the lower support is fixed to the lower cover, wherein the mounting support is vertically arranged, and the upper support and the lower support are located on the same reference plane after being assembled.

12. The actuator capable of providing a linear thrust of claim 1, wherein the actuator further comprises a tube sleeve, and the tube sleeve is sleeved outside the screw rod.

13. The actuator capable of providing a linear thrust of claim 1, wherein the actuator further comprises a mounting support used for mounting the actuator, wherein the mounting support comprises an upper support and a lower support, wherein the upper support is fixed to the upper cover, and the lower support is fixed to the lower cover, wherein both the upper support and the lower support are respectively provided with a U-shaped groove.

14. The actuator capable of providing a linear thrust of claim 1, wherein the actuator further comprises two damping pieces, wherein each damping piece comprises a circular ring portion and a plurality of convex bodies that protrude out from the circular ring portion, wherein the circular ring portion is fixed to the convex bodies, and the convex bodies are symmetrically arranged on the periphery of the circular ring portion, wherein the two damping pieces are respectively arranged on two sides of the worm gear, wherein the convex bodies abut against the upper cover and the lower cover.
